(19) United States
(12) Patent Application Publication
(10) Pub. No.: US 2003/0041072 A1
(43) Pub. Date: Feb. 27, 2003

(54) Methodology for constructing and optimizing a self-populating directory

(76) Inventors: Irit Haviv Segal, Tel-Aviv (IL); Amir Winer, Tel-Aviv (IL)

Correspondence Address: Jefferson Perkins, PIPER RUDNICK, P.O. Box 64807, Chicago, IL, 60664-0807, US

(21) Appl. No.: 10/229,752

(22) Filed: Aug. 27, 2002

Related U.S. Application Data
(60) Provisional application No. 60/314,643, filed on Aug. 27, 2001.

(51) Int. Cl. G06F 7/00

(52) U.S. Cl. 707/104.1

(57) ABSTRACT

A systematic method for detecting meta-ideas used to expanding a skeletal structure. The folder label for each individual first level skeletal folder is placed in a separate collection, and predefined noise words are removed therefrom. A table is tabulated for each collection counting the single word frequency of each word. Words whose frequency falls below a predetermined threshold are removed from the each frequency table. A combined frequency table is created by joining the individual frequency tables wherein meta-ideas are extrapolated from the results of the combined frequency table.

### RELATED APPLICATION(S)

This specification is related to U.S. application Ser. No. 09/845,196 filed May 1, 2001 entitled “METHOD FOR CREATING CONTENT ORIENTED DATABASES AND CONTENT FILES” which was submitted by the assignee of the present invention.

This specification is related to and incorporates herein by reference U.S. application Ser. No. xx/xxx,xxx, entitled “METHOD FOR DEFINING AND OPTIMIZING CRITERIA USED TO DETECT A CONTEXTUALY SPECIFIC CONCEPT WITHIN A PARAGRAPH” which was filed concurrent with the present invention.

### CLAIM FOR PRIORITY

This application claims priority under 35 U.S.C. 120 of U.S. Provisional Application Serial No. 60/314,643 filed Aug. 27, 2001, and which is entitled AUTOMATED FORMATION OF A MODULAR STRUCTURE OF KNOWLEDGE USING MULTI-LINGUAL WORD STEMS”.

### FIELD OF THE INVENTION

The present invention relates to a method for constructing and optimizing a directory structure and tools facilitating the same.

### BACKGROUND OF THE INVENTION

The utility of a directory is determined in relation to its breadth and its depth. The granularity of a directory is reflected in the number and length of the branches. If a directory does not have sufficient granularity it will not segregate relevant records from irrelevant records. If the number or length of the branches in the directory exceeds a critical number it may become unwieldy for the user to use.

Conventionally, directory structures are created manually by dividing a topic or field of knowledge into sub-topics, and then subdividing each sub-topic into further sub-topics until a desired level of granularity is reached. An improper selection of topics or sub-topics will result in the loss of information which is not mapped onto any sub-topic, or the mapping of the information to an overly general topic. Moreover, the list of topics or sub-topics must be dynamic to capture ongoing developments in the field of knowledge.

Unfortunately, the prior art fails to disclose or suggest a systematic way for defining a directory structure or for detecting topics or sub-topics which should be added to a directory structure.

### BRIEF DESCRIPTION OF THE DRAWINGS

FIG. 1 is a directory;

FIG. 2A is a skeletal structure;

FIG. 2B is a framework structure;

FIG. 3 is a flow diagram for expanding and optimizing a skeletal structure;

FIG. 4 is a flowchart for creating framework structure;

FIGS. 5A and 5B are collections of labels;

FIG. 6 is a sample compilation of noise words;

FIG. 7 shows a pointer linking a paragraph to folder;

FIG. 8 shows the coordinates of paragraph within a file;

FIG. 9 is a frequency table;

FIG. 10 is a sample thesaurus;

FIG. 11 shows the framework structure (FIG. 2B) appended to the skeletal structure (FIG. 2A);

FIG. 12 is a flow diagram of the process for further expanding the skeletal structure;

FIG. 13A shows a sample folder label;

FIG. 13B shows a redacted label created by removing noise words from the label of FIG. 13A;

FIG. 14 shows the label and definition for an expansion folder;

FIG. 15 is table showing the rules for replacing prefixes and suffixes for the duplicated stems;

FIG. 16 is a Venn diagram showing the overlap between two folders;

FIG. 17 is a flow diagram of the process for organizing the files into a more logical hierarchy;

FIG. 18 shows an unmatched folder added to a directory for detecting missing skeletal folders.

### DETAILED DESCRIPTION OF THE PREFERRED EMBODIMENTS

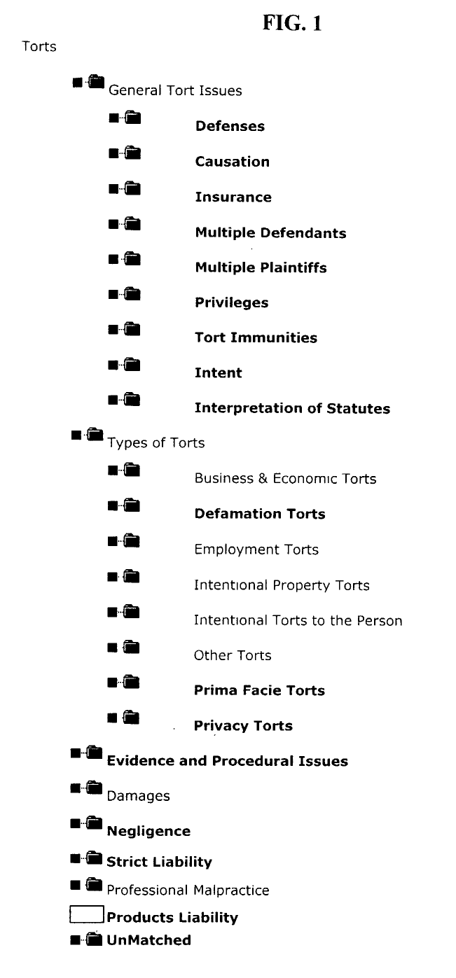

The present invention provides a methodology for automatically expanding and optimizing a directory of a field of knowledge. A directory 100 (FIG. 1) is a hierarchical collection of content folders 102 to which text expressing a specified concept is mapped. Notably, each content folder 102 is associated with a particular concept or idea (label 106) and with criteria (definition 108) for detecting the concept within a paragraph or textual fragment, where a textual fragment is a unit of text which is defined in terms of a number of sentences or paragraphs. Textual fragments are compared against the criteria (definition 108) of the respective folders 102 according to pre-defined rules, with textual fragments satisfying the criteria being mapped to the folder(s).

The position of the content folder 102 within the directory 100 defines the context for interpreting the concept. The methodology of the present invention provides a one-to-one function between the definition 108 of a content folder 102 and the contextual meaning of the folder's concept.

Definitions of Textual Units—As used herein, a file is a document, web site or the like containing at least one paragraph of text. A paragraph is defined as a text string terminated by paragraph termination symbol such as “¶” or the like, or one or more blank lines. If the text in the file does not contain any recognized paragraph notation then the entire text string is considered to be a single paragraph. A textual fragment is the basic unit of text mapped to the directory. A textual fragment may be defined in terms of a number of words, sentences or paragraphs. According to a presently preferred embodiment, a paragraph is the basic unit of text which is interrogated to locate a desired concept.

Definition of a Directory—A directory 100 is a hierarchical structure of content folders to which files or textual fragments containing specific concepts have been mapped. Thus, a directory structure becomes a directory after the paragraphs or textual fragments are mapped to the content folders 102. As used in the present disclosure, the initial unmapped directory structure is known as a skeletal structure 110.

FIG. 1 is a sample directory 100 of content folders 102, including a root folder 102-A and plural sub-folders 102-B. The last folder 102 on a particular branch 104 is termed an end folder, e.g., folder 102-B_{end}.

The methodology of the present invention is used to expand and optimize the granularity of the skeletal structure 110. The skeletal structure 110 is simply a rudimentary arrangement of topics and sub-topics for a given subject or field of knowledge.

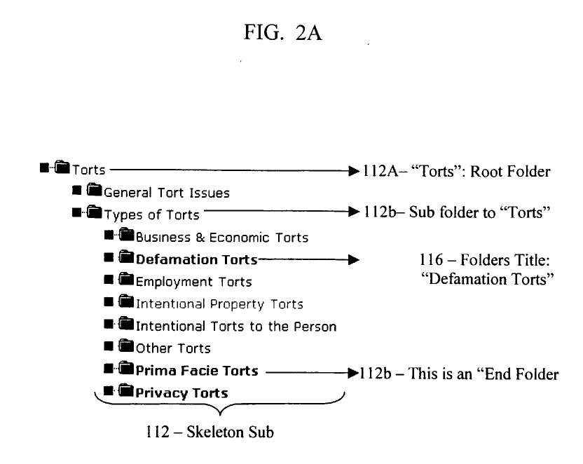

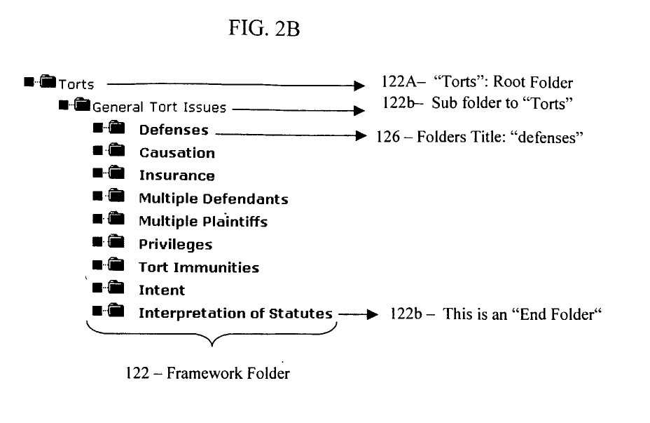

Skeletal Structure Definition—FIG. 2A is a skeletal structure 110 having plural content folders 112 in which folder 112-A is a root folder, folders 112-B are sub-folders, and folders 112-B_{end} are end-folders. The folders 112 are arranged in branches 114; each folder 112 has a single parent folder except the root folder which has no parent folder.

Each skeletal folder 112 is associated with a label 106 and a definition 108. The label 106 describes the concept or topic of the folder 112, and definition 108 contains criterion for detecting the expression of the concept within a paragraph.

It is important to appreciate that concepts are detected on a paragraph by paragraph basis, enabling the user to hone in on the precise paragraph conveying a desired concept.

Each skeletal folder 112 has a unique label 106 to reflect the fact that the concept associated with the skeletal folder 112 is unique within the directory.

The skeletal folder definition 108 is specified using the methodology disclosed in U.S. application Ser. No. XX/XXX,XXX entitled “METHOD FOR DEFINING AND OPTIMIZING CRITERIA USED TO DETECT A CONTEXTUALY SPECIFIC CONCEPT WITHIN A PARAGRAPH” which was filed concurrent with the present application.

Framework Structure Definition—A separate structure known as a framework structure 120 is used to expand the granularity of the skeletal structure 110. The framework structure 120 is a set of sub-topics used to expand the topics of the skeletal structure 110. The subtopics within the framework structure 120 represent the complete set of meta-ideas necessary to define the characteristics of any concept within the skeletal structure 110. As will be explained below, the framework structure 120 is automatically generated from the paragraphs mapped to the skeletal folders 122.

FIG. 2B is a framework structure 120 having plural framework (content) folders 122 in which framework folder 122-A is a root folder, framework folders 122-B are sub-folders, and framework folders 122-B_{end} are end-folders. The framework folders 122 are arranged in branches 114, each folder 122-B has a single parent folder, and the root folder 122-A has no parent folder.

Each framework folder 122 is associated with a label 126 and a definition 128. The label 126 describes the concept or topic of the folder 122, and definition 128 contains criterion for detecting the expression of the concept within a paragraph.

The framework folder definition 128 is specified using the methodology disclosed in U.S. application Ser. No. XX/XXX,XXX entitled “METHOD FOR DEFINING AND OPTIMIZING CRITERIA USED TO DETECT A CONTEXTUALY SPECIFIC CONCEPT WITHIN A PARAGRAPH” which was filed concurrent with the present application.

It should be appreciated that while the same methodology is used to specify the folder definitions 108 and 128, there is a basic conceptual difference between the two types of folders which is expressed in the way the definition 108, 128 is specified.

The skeletal folders 112 are used to define the different subjects or categories of the field of knowledge, whereas the framework folders 122 are used define characteristics of the skeletal folder 112.

The characteristics or concepts associated with each of the framework folders 122 generically describe the concepts associated with the skeletal folders 112. The “generic” concept of the framework folders 122 only becomes specific when a context is supplied. As will be explained below, the framework folders 122 inherit the contextual criterion from the skeletal folders 112.

The methodology for specifying the folder definition disclosed in U.S. application Ser. No. XX/XXX,XXX entitled “METHOD FOR DEFINING AND OPTIMIZING CRITERIA USED TO DETECT A CONTEXTUALY SPECIFIC CONCEPT WITHIN A PARAGRAPH”, includes a concept of inheritance. Inheritance refers to the situation in which selected criterion (Master Phrases) provided in the skeletal folder definition 108 is inherited by hierarchically subordinate framework folders 122.

As described in the methodology of the related application, Master Phrases are advantageously used to specify the context criterion. The use of Master Phrases in the folder definition 108 of the skeleton folders 112 eliminates the need to individually specify context criterion in each of the hierarchically subordinate framework folders 122. Thus, the context of hierarchically subordinate framework folders 122 is dynamically defined (inherited) when the framework folder 122 is added to the directory structure.

Roadmap

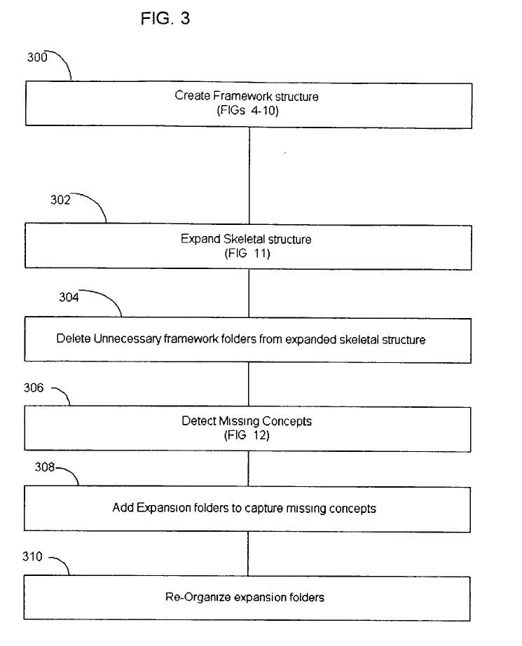

FIG. 3 is a high level flow diagram providing a roadmap of the methodology for expanding and optimizing a skeletal structure (initial directory structure).

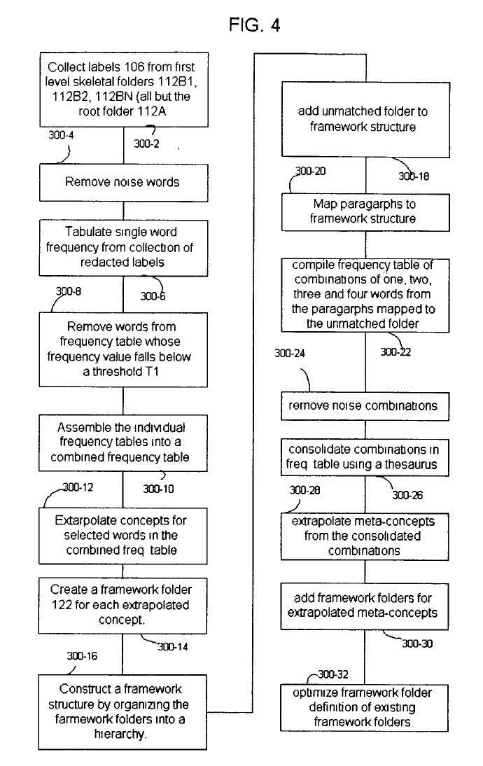

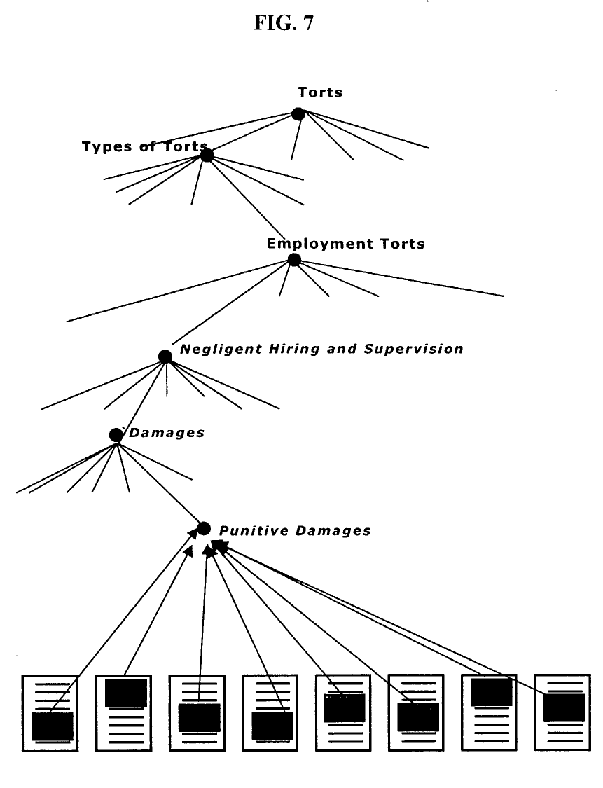

STEP 300—As shown, the process begins with the creation of the framework structure 120 which will be explained below with reference to FIGS. 4-10.

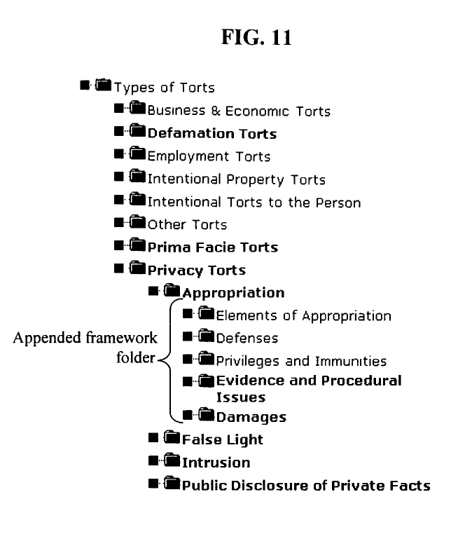

A step 302-304—The skeletal structure 110 is expanded by appending the framework structure to each of the end-folders 112-B_{end} of the Skeletal Structure (Step 302), and irrelevant framework folders are deleted (step 304). The processes associated with each of these steps will be explained below with reference to FIG. 11.

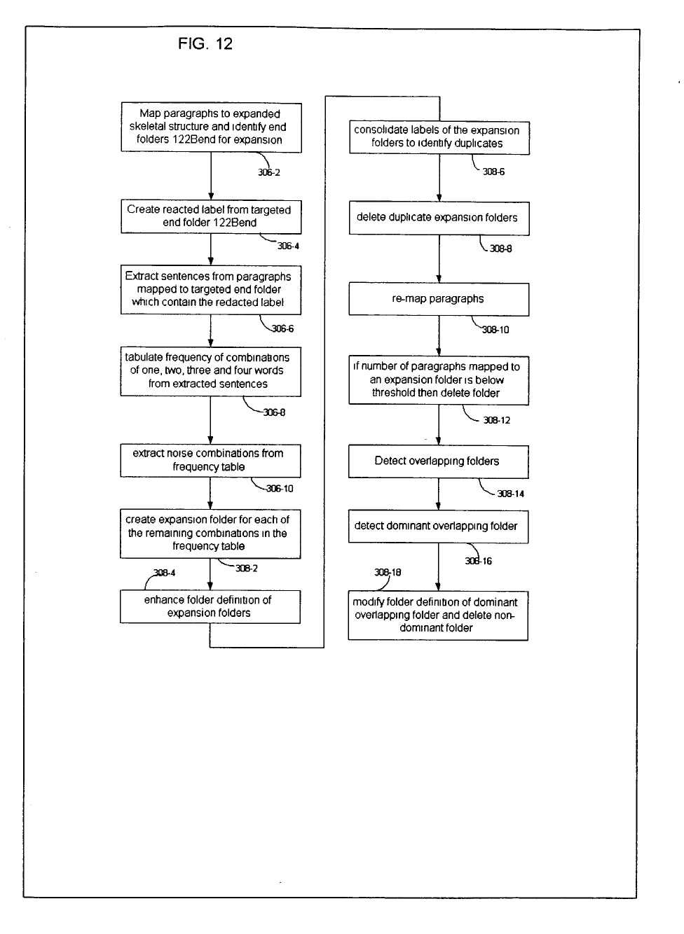

STEPs 306-308—An iterative process is executed to detect potential concepts missing from the skeletal structure 110 (step 306) and add expansion folders 130 to capture the missing concepts (step 308). The processes associated with these steps will be explained below with reference to FIGS. 12-20.

Step 300—Creation of the Framework Structure

FIG. 4 is a flow diagram of the algorithm for creating the framework structure.

This process is used to detect the characteristics (meta-ideas) which will be used to increase the granularity of the skeletal structure (initial directory structure) 110. The detected meta-ideas will be organized into a framework structure 120 which will be used to systematically expand the skeletal structure 110.

The disclosed process for detecting meta-ideas was determined empirically. Other processes are contemplated and fall within the scope and spirit of the present invention.

According to a presently preferred embodiment, the meta-ideas are determined by performing statistical processes on labels (concept or topic) 106 of the skeletal folders 112.

As shown in FIG. 2A, the first level of folders 112B1, 112B2, . . . , 112Bn are hierarchically subordinate to the root folder 112A and represent the general topics of the skeletal structure 110. More particularly, the general topics are described in the labels 106 associated with each of the first level of folders 112B1, 112B2, . . . , 112Bn.

Label Collection—The process begins with collecting the (concepts) labels 106 from all of the content folders 112B1₁ through 112B1ₙ for all of the branches 114 hierarchically subordinate to a selected first level folder 112B1 into a collection 118-1 (step 300-2). Step 300-2 is repeated for each of the first level folders 112B2, 112B3, . . . , 112Bn, collecting the labels 106 into separate collections 118-2, 118-3, . . . , 118-n.

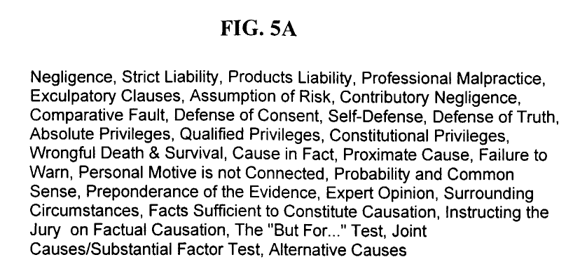

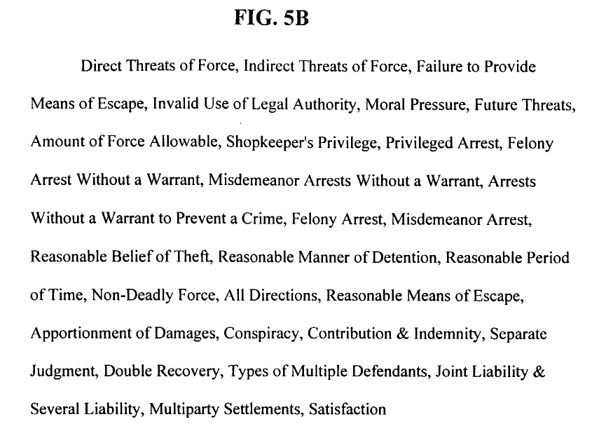

In the sample skeletal structure 110 shown in FIG. 2A, folders 112B₁ through 112B1ₙ are all hierarchically subordinate to 112B1. FIGS. 5A and 5B are collections of labels for 112B1 and 112B2.

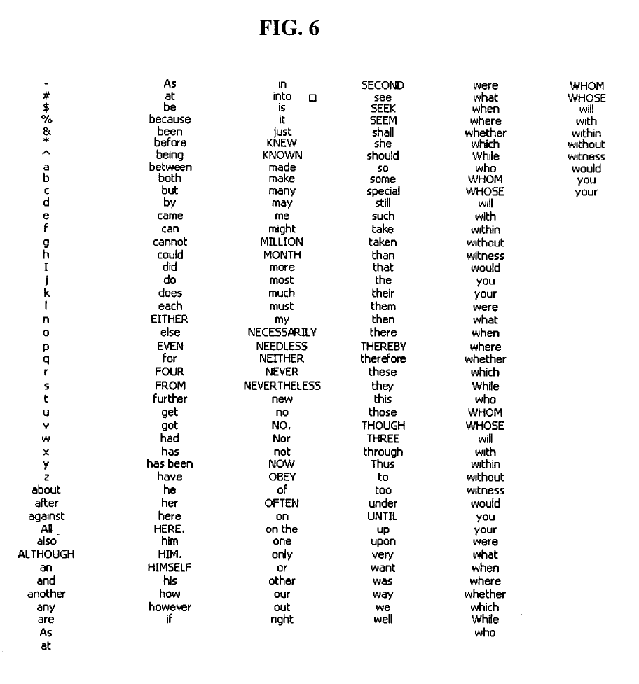

Removal of Noise Words—Noise words are defined as words that do not have relevance to the directory as a whole. Such noise words typically include digits, dates, seasons, punctuation, single letters, symbols such as “&”, currency symbols, participles such as “a”, an”, “the”, and the like. Noise words and noise characters are deleted from each of the collections of labels 118-1, 118-2, and 118-3 . . . 118-n (step 300-4) to create a collection of redacted labels. A sample list of noise words is provided in FIG. 6. In FIGS. 5A and 5B, the noise words within each of the collections of labels are shown circled. The redacted labels 106 each include at least one word.

Statistical Processes—A frequency table 150-1, 150-2 . . . 150-n is tabulated for each word in the label collections labels 118-1, 118-2, 118-3, . . . , 118-n. The frequency table 150 counts the number of times each word occurs within a given collection of redacted labels (step 300-6).

In the frequency table 150, a low frequency signifies a word which is unlikely to represent a meta-idea relevant to the framework structure 120. Thus, words whose frequency is below a threshold level TI are removed from further consideration (step 300-8).

According to a presently preferred embodiment, Ti is calculated by taking the frequency value of the highest combination and dividing it by the average frequency of the top 100 words. However, other ways for determining threshold Ti are contemplated, and are readily appreciated by one of ordinary skill in the art.

A combined frequency table 170 is compiled by combining the frequency rankings from each of the individual frequency tables 150-1, 150-2 . . . 150-n from (step 300-10).

Empirical evidence has shown that the words (which were taken from the folder labels 106) which occur with the highest frequency within the combined frequency table 170 are likely to be associated with issues which should be included in the framework structure 120.

The user extrapolates meta-ideas 172 or concepts from the words in the combined frequency table 170 based on his/her knowledge of the subject of the directory. In other words, the user knows from experience that selected words (terminology) are used to describe a meta-idea 172. The user determines whether it is necessary to create a new framework folder 122 for the meta-idea 172, or whether the concept definition 128 of an existing (meta-idea) framework folder 122 needs to be optimized to detect the words in the combined frequency table 170 (step 300-12).

In operation, results of the combined frequency table 170 are presented to the user. The user examines the words to identify a number of unifying concepts or meta-ideas 172 which may be extrapolated from the words in the combined frequency table 170.

A framework folder 122 is created for each meta-idea 172 (step 300-14), wherein the folder label 106 is the meta-idea 172. The folder definition 128 is created to capture the word(s) from which the meta-idea was extrapolated. However, the folder definition 128 must be expansive because the meta-idea 172 may be associated with other words which were not reflected in the combined frequency table 170.

Again, the concept definition 128 is specified using the methodology disclosed in U.S. Ser. No. XX/XXX,XXX entitled “METHODOLOGY FOR CAPTURING THE CONTEXTUAL MEANING OF CONCEPTS OR IDEAS WITHIN A PARAGRAPH”.

The framework structure 120 is created by hierarchically organizing the framework folders (meta-ideas) 122 based on the user's knowledge of the subject of the directory (step 300-16). Since each of the met-ideas is generic, the hierarchy may be flat.

As will be explained below, the framework structure 120 in FIG. 2B is used to elaborate the skeletal structure 110 (initial directory structure) shown in FIG. 2A. The framework folders 122 (FIG. 2B) correspond to the meta-ideas 172.

Validating the Framework Structure

A validation process is used to verify whether the framework structure 120 is sufficiently robust to capture all the relevant concepts.

A special content folder termed an unmatched folder 124 is appended to the root folder 122A of the framework structure 120 (step 300-18). See FIG. 2B. Like any other content folder, the unmatched folder 124 has a label 126 and a definition 128.

The folder definition 128 of the unmatched folder 124 is specified to capture all paragraphs (textual fragments) which were not mapped to any other framework folder 122.

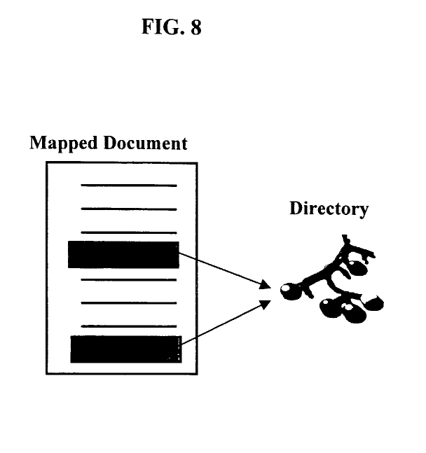

Mapping of a paragraph to a folder 122 entails associating a pointer 140 with the paragraph, and linking the folder 122 with the pointer 140. See FIG. 8A. The location of a paragraph within a file is identified by coordinates 142 which identify the file (document) and relative position of paragraph within the file. See FIG. 8B.

Paragraphs are mapped to the framework structure 120 by comparing each paragraph with the folder definitions 128 (300-20). Again, the mapping process is disclosed in U.S. application Ser. No. 09/845,196 filed May 1, 2001 entitled “METHOD FOR CREATING CONTENT ORIENTED DATABASES AND CONTENT FILES”.

By definition paragraphs which were mapped to the unmatched folder 124 were not mapped to any other folder 122 within the framework structure 120. Thus, it is necessary to determine whether these paragraphs contain pertinent concepts which should be added to the framework structure 120.

The process for identifying concepts for inclusion in the framework structure is similar to the process of steps 300-2 through 300-12.

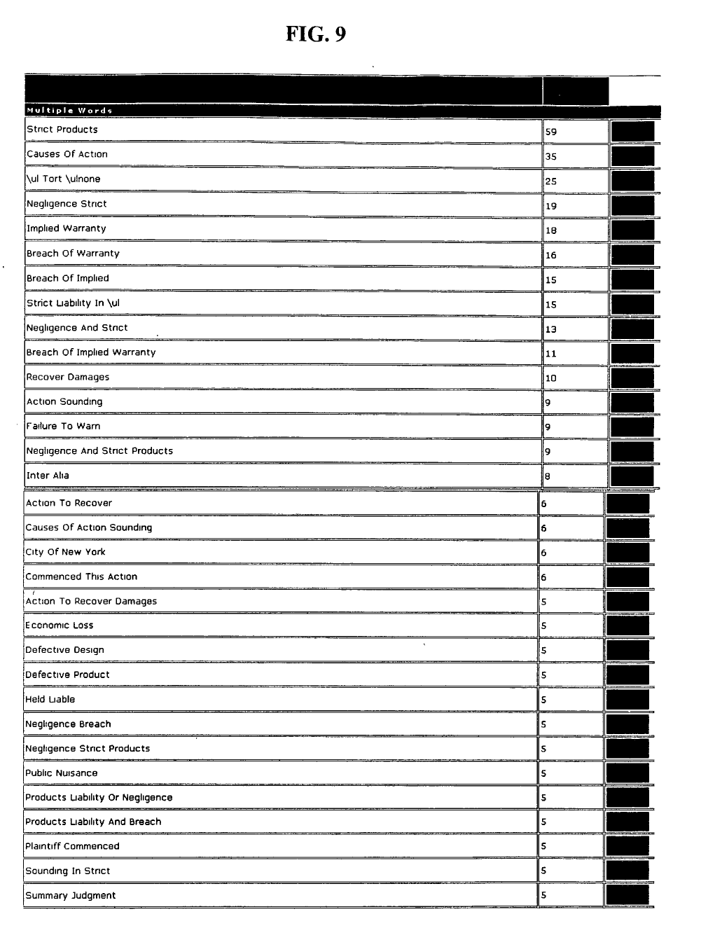

A frequency table 180 (FIG. 9) is compiled from the paragraphs mapped to the unmatched folder 124 (step 300-22). The frequency table 180 includes one, two, three and four word combinations from each sentence within the paragraphs mapped to the unmatched folder 124.

Noise combinations in the frequency table 180 are removed from further consideration (step 300-24). According to a presently preferred embodiment, noise combinations are determined using first and second threshold values, however, acceptable results may also be obtained using only the second threshold value.

The first threshold is empirically determined as a positional frequency. According to a presently preferred embodiment, the first threshold is defined to exclude the top two most frequently occurring combinations.

A second threshold is calculated by taking the frequency value of the highest combination that is smaller than the first threshold and dividing it by the average frequency of the top 100 combinations.

Extract word combinations whose frequency is lower than a first threshold but higher than a second threshold.

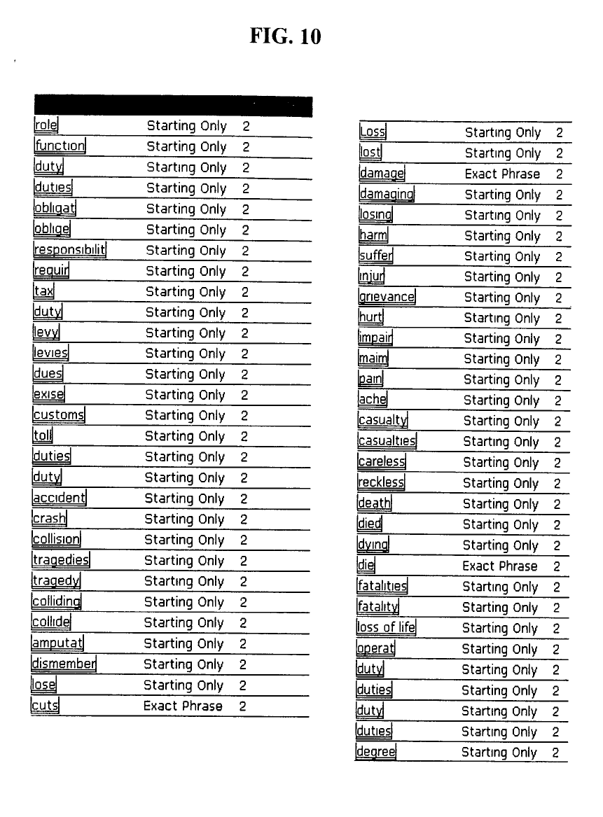

A thesaurus 160 is table of records 162, where each record 162 contains synonymous terminology within the context of a specific field of knowledge. FIG. 10 is a sample thesaurus 160 of legal terminology.

The thesaurus 160 is used to detect synonymous terminology within the frequency table 180. The synonymous terminology and its associated frequency values are removed from the frequency table 180, and replaced by a single synonymous word or word combination with a frequency value calculated as the sum of the individual frequencies of the synonymous terminology (step 300-26).

It is now necessary to examine the word combinations in the frequency table 180 to determine whether the combinations are indicative of framework folders (concepts) 122 missing from the framework structure 120, or whether the folder definition 128 of an existing framework folder 122 should be optimized to detect the word combination. More precisely, the user extrapolates concepts from the word combinations in the frequency table 180 based on his/her knowledge of the subject of the directory (step 300-28).

The user knows from experience that selected word combinations are used to describe a selected concept, and then checks whether an existing framework folder 122 corresponds to the extrapolated concept. If so, the concept definition 128 of the corresponding framework folder 122 needs to be optimized to detect the word combination (step 300-30).

If no framework folder 122 corresponds to the extrapolated concept, then a new framework folder 122 may need to be defined whose concept definition detects the word combination (step 300-32). Alternatively, the word combination may be irrelevant (noise) to the framework structure 120.

It should be appreciated that the above process for detecting missing framework folders 122 should be executed periodically to ensure that newly evolving concepts are included in the framework structure 120 as new framework folders 122 or existing concept definitions 128 are optimized to detect new terminology.

Steps 302-304 Creating Initial Directory Structure (FIG. 11)

At this stage in the process, we have two distinct structures, the skeletal structure 110 and the framework structure 120.

The granularity of the skeletal structure 110 is expanded using the framework structure 120. More particularly, a copy of the framework structure 120 is appended to each end-folder 112B_{end} of the skeletal structure 110 (302-2).

As will be explained below, additional step are necessary to further expand and optimize the skeletal structure 110.

FIG. 11 shows the how the skeletal structure 110 of FIG. 2A is expanded by appending the framework structure 110 from FIG. 2B to each of the end-folder 112B_{end}.

It is now necessary to remove unnecessary framework folders 122 from the newly expanded skeletal structure 110. Notably, some of the framework folders 122 may not be relevant within the context of a particular skeletal folder 112. This determination is made by mapping a sample collection of paragraphs to the expanded skeletal structure (step 304-2).

The number of paragraphs mapped to each of the framework folders 122 is tabulated (step 304-4). See FIG. 3.

If less than a threshold level of paragraphs is mapped to any framework folder 122 it is judged to be unnecessary and is deleted from the expanded skeletal structure 110.

Steps 306-308 Expanding (Elaborating) the Directory Structure

FIG. 12 is a flow diagram of the process for further expanding the skeletal structure 110.

Step 306-02—The first step in the process involves mapping a collection of paragraphs to the skeletal structure, and tabulating the number of paragraphs mapped to each of the end-folders 122B_{end}. Folders having more than a critical number of mapped paragraphs are targeted for expansion.

It is now necessary to automatically generate a set of prospective expansion folders 130 for expanding the targeted framework end-folder 122B_{end}.

Automated Process for Generating Prospective Skeletal Folders 112

Step 306-04—For each of the targeted end-folder 122B_{end}, create a redacted label 126_{red} by removing noise words (e.g., FIG. 6) from the folder's label 126.

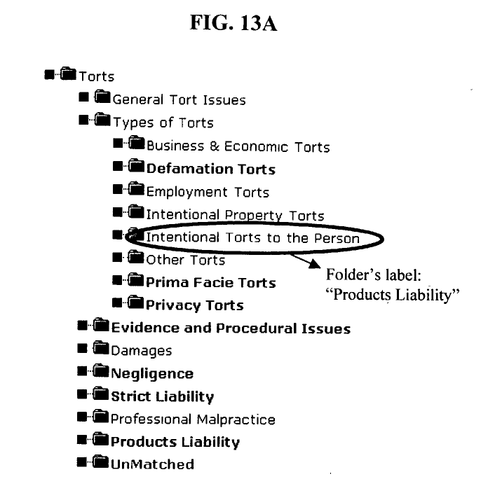

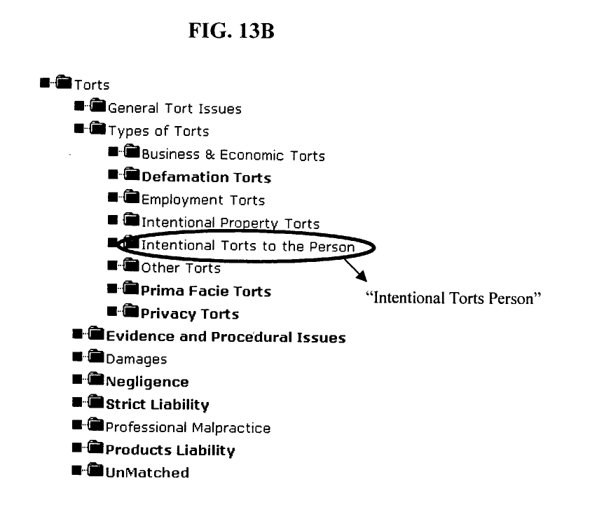

By manner of illustration, FIG. 13A shows a label 126 and FIG. 13B shows a redacted label 126_{red} created by removing noise words (FIG. 6) from the label 126.

Step 306-06—For each of the paragraphs (textual fragments) mapped to a targeted end-folder 122B_{end}, extract sentences which contain the redacted folder label 126_{red}.

Step 306-08—Tabulate a frequency table 180 of two, three four words combinations that re-occur in the extracted sentences. See FIG. 9. These word combinations represent concepts which will be used to expand the targeted framework end folder 122B_{end}.

Step 306-10—Noise combinations in the frequency table are removed from further consideration. According to a presently preferred embodiment, noise combinations are determined using first and second threshold values, however, acceptable results may also be obtained using only the second threshold value.

Extract word combinations whose frequency is higher than a first threshold or lower than a second threshold. The first and second threshold limits are used to exclude irrelevant combinations (noise).

According to a presently preferred embodiment the first threshold is empirically determined as a positional frequency. For example, the first threshold may be defined to exclude the top two most frequently occurring combinations. Experience has shown that word combinations whose frequency is higher than the first threshold are noise combinations, i.e., irrelevant combinations.

According to a presently preferred embodiment the second threshold is calculated by taking the frequency value of the highest combination that is smaller than the first threshold and dividing it by the average frequency of the top N combinations. If the value of N is too small then the average frequency will be skewed towards the highly occurring combinations, and too many combinations will be excluded. Conversely, if the value of N is too large then the average frequency will be relatively low, and too many combinations will be included. The inventors of the present invention have found that setting N to be 100 produces a manageable number of combinations. However, other values of N may be appropriate depending on the dataset of files being mapped.

Step 306-10 will be explained with reference to the frequency table 180 of FIG. 9. Let us assume that the first positional threshold is the second highest frequency, and N=100. The top two most frequently occurring word combinations are extracted, and then the second threshold is computed as the average frequency of top 100 remaining word combinations. Word combinations whose frequency value falls below the second threshold are extracted.

Again, the word combinations represent concepts which may be used to expand the targeted framework end folder 122B_{end}.

Out of the remaining word combinations (word combinations falling within the two thresholds), retain only the first M combinations. If the value of M is too large then the table 180 will contain many irrelevant word combinations. Conversely, if the value of M is too small then the table 180 will omit many relevant word combinations. The inventors of the present invention have found that setting M to be 100 produces a manageable number of combinations. However, other values of M may be appropriate depending on the dataset of files being mapped.

Step 308-02—It is now necessary to create an expansion folder 130 for each of the concepts in the table 180. Again, each expansion folder 130 must have a label 136 and a folder definition 138. The label 136 is determined as a word combination from the table 180, and the folder definition 138 is created using the methodology of the related application.

Each word combination in table 180 is a combination of two, three or four words. Each word in the combination is set as a stem phrase and proximity and order restrictions are imposed to preserve the appearance of the original word combination.

More particularly, the folder definition 138 includes a first Stem Group created from the word combination and the definition of the parent folder, and a second Stem Group created from the word combination and the definition of the grand-parent folder.

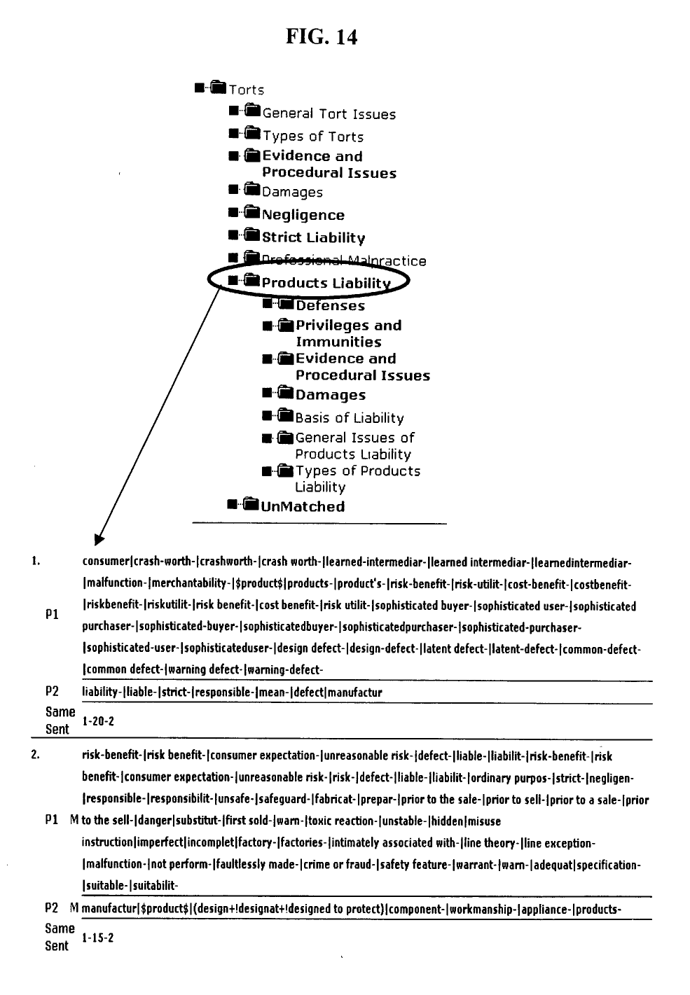

FIG. 14 shows the label 136 and folder definition 138 for a sample expansion folder 130 created from the table 180 (FIG. 9).

Step 308-04—Next the Stem Phrases of each of the newly created Stem Groups of the new Multi-Stem Group are enhanced. The thesaurus 160 (FIG. 10) is used to add synonyms of every stem to every Stem Phrase.

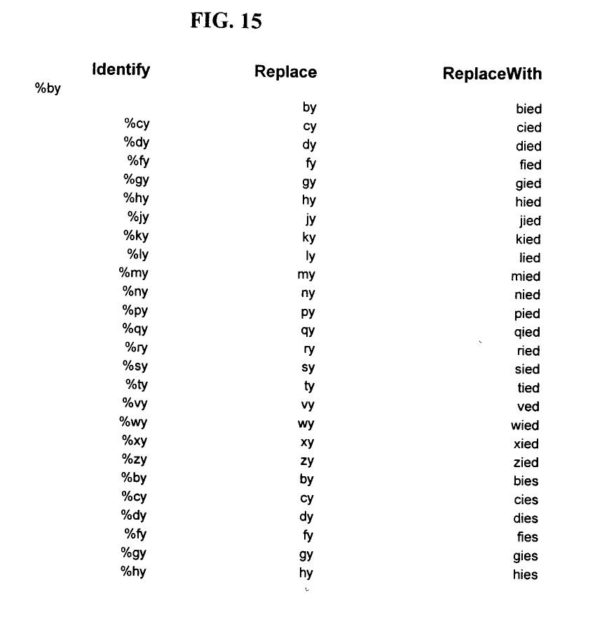

At this stage, each of the stems in the Stem Group is a word taken from the framework folder's label 128. In order to create a more robust Stem Phrase, we duplicate each of the stems with different prefixes and suffixes using predefined. FIG. 15 is a sample table showing the rules for replacing prefixes and suffixes for the duplicated stems.

Detecting Unnecessary Expansion Folders 130

The automatically generated expansion folders 130 include redundant folders, i.e., folders which have the same folder definition 138 but slightly different labels 136. These labels 136 are essentially identical apart from minor differences in prefixes and suffixes.

Step 308-06—The prefixes and suffixes from the words comprising the folder label 106 are deleted or replaced using predefined criteria. FIG. 15 is a table containing sample criteria for deleting or replacing the prefixes and suffixes.

Step 308-08—If two or more folders have the same label 138, then only one of the folders is retained. An arbitrary one of the set of redundant folders 130 may be retained, as it is assumed that an identical label indicates an identical folder definition 138.

Steps 308-10—The paragraphs mapped to the parent folder (target end-folder) are re-mapped to the newly created sub-folders.

Step 308-12—If the number of paragraphs mapped to an expansion folder 130 is below a threshold level calculated as a percentage of the total number of paragraphs originally mapped to parent folder, then the sub-folder is deleted.

Still further, duplicative (redundant) expansion folders 130 may be detected by examining the overlap between a selected pair of folders. To facilitate understanding let us designate one of the folders A and the other B. If the two folders share a large number of paragraphs it indicates that one of the folders is redundant.

Empirical evidence has demonstrated that if the number of mutual paragraphs exceeds a threshold percentage L then one of the folders is deemed to be redundant. For the sake of example, let us assume that L is 75%.

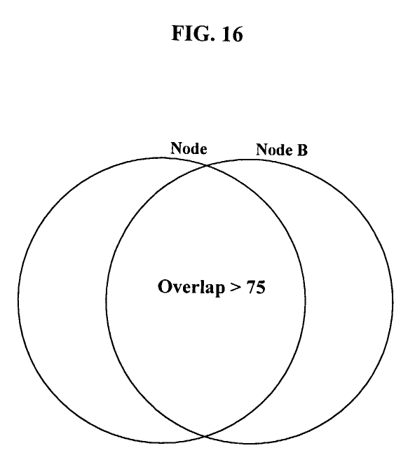

Step 308-14—The calculation is performed by checking whether the paragraphs (textual fragments) within the intersection of A and B is greater than 75% of the number of paragraphs within the union of A and B. See FIG. 16. If so, then one of the skeletal folders 130 is redundant, and it is now necessary to determine which of the folders should be retained.

The expansion folder 130 which is most closely related to the paragraphs contained in the intersection of A and B is retained. As will be explained, the redundant folder is deleted, and the definition of the non-redundant folder is modified to map the paragraphs (textual fragments) not included in the intersection.

The skeletal folder to be retained is determined by calculating a relevance factor R for each folder (step 308-16). The relevance factor is determined by dividing the number of paragraphs within the intersection of A and B by the total number of Paragraphs mapped to the folder. Let us assume that there are 15 paragraphs within the intersection of A and B, 25 paragraphs in A and 35 paragraphs in B. Then folder A is retained since 15/25>15/35.

The folder definition 138 of the redundant expansion folder 130, i.e., its Multi-Stem Group is added to the folder definition 138 of the retained expansion folder 130, and the redundant expansion folder 130 is deleted (308-18).

Steps 308-14 through 308-18 are repeated until there is no mutual overlap of over 75% between the folders. The end result is a flat arrangement of folders.

Step 310 Organizing the Expansion Files 130 into a Hierarchy

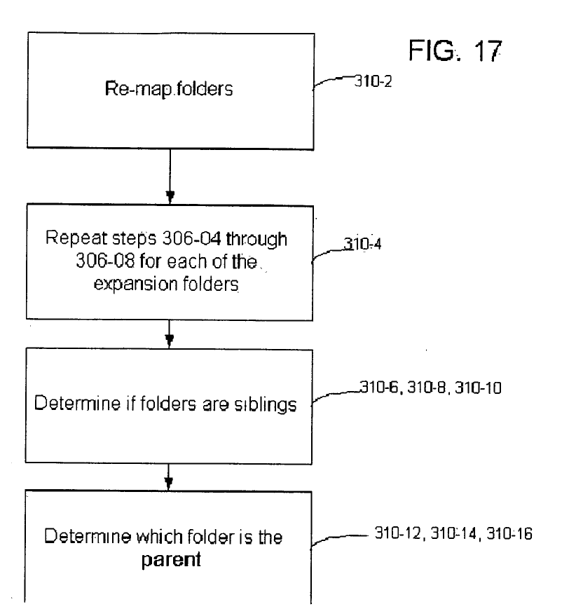

FIG. 17 is a flow diagram of the process for organizing the expansion files 130 into a more logical hierarchy beneath the target end-folder 122b_{end}. This process detects which expansion folders 130 have less than a threshold degree of commonality (sibling folders) and should remain on the same hierarchical level, and which expansion folders 130 should be arranged in a parent-child relationship.

It should be appreciated that at this stage, duplicative expansion folders 130 have been removed. According to the presently preferred embodiment, duplicative folders were defined as folders which have a 75% overlap of mapped paragraphs. The remaining folders are related by less than the threshold (75%) overlap.

Sibling Test

For the purposes of explaining the sibling test, let us designate the newly created expansion folders as D1 through Dn, and designate the target end-folder122b_{end} as C.

A collection of paragraphs are mapped to folders D1 through Dn and C (step 310-02).

Steps 306-04 through 306-08 (FIG. 12) are executed for each of the folders D1 through Dn and C, yielding for each a frequency table 180 (FIG. 9) of two, three and four word combinations (step 310-04).

Part 1 of the Sibling Test

If the number of mutual paragraphs between D1 and D2 is zero, then D1 and D2 are siblings (step 310-06). This pre-screening is repeated for D1 and D3, D1 and D4 through D1 and Dn.

Part 2 of the Sibling Test

Check whether the label of D2 through Dn matches any of the combinations in the frequency table of D1 (Step 310-08)

If the label of Dn does not match any of the combinations in the frequency table of D1, then D1 and Dn are regarded as siblings (step 310-10).

Parent Child Relationship Test

If the folders D1 and Dn are not determined to be siblings using the two part sibling test, then we know that the folders belong in a parent-child relationship, but it remains to be determined which folder is the parent and which the child.

From the second part of the sibling test, we know that the label of D2 through Dn matches one of the combinations in the frequency table of D1.

C₁, C₂, Cₙ are the ranked frequencies from the frequency table of C.

D1₁, D1_{2.} D1ₙ are the first, second and n-th ranked frequencies from the frequency table of D1.

D2₁, D2₂ . . . D2ₙ are the first, second and n-th ranked frequencies from the frequency table of D2.

CD1 is the frequency value of the name of D1 within the frequency table of C.

D1Dn is the frequency value of the name of Dn within the frequency table of D1.

DnD1 is the frequency value of the name of D1 within the frequency table of Dn.

R1 is defined as C2/CD1.

R2 is defined as D11/D1D2.

R3 is defined as D22/D2D1.

R4 is defined as C2/CD11.

| | |
|---|---|
| If R1 > R2 then | (Step 310-12) |

| No - D1 is the parent of D2 | |
|---|---|
| Yes - If R4 > R3 then | (step 310-14) |

| No - D2 is the parent of D1 | |
|---|---|
| Yes - If CD2 > CD1 then | (step 310-16) |

No - D1 is the parent of D2
Yes - D2 is the parent of D1

Using Unmatched Node to Detect Blind Spots

In the present context, blind spots are topics which are not captured by any of the content folders 112, 122, 130 within the directory structure.

As before, blind spots are detected using the unmatched folder 124, where the unmatched folder is a content folder whose folder definition 108 is constructed to capture paragraphs which are not mapped to any other content folder 112, 122, 130.

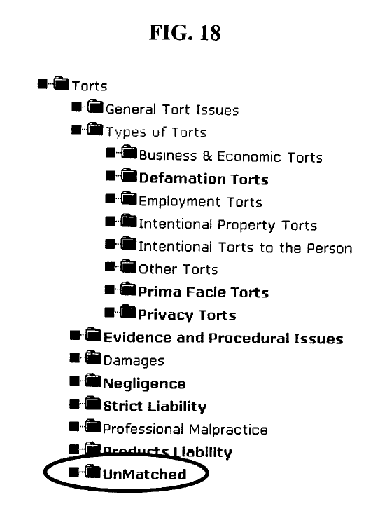

As shown in FIG. 18, the unmatched folders 124 are attached to the directory 100 on the same hierarchical level as the end-nodes 112B_{end} of the skeletal framework within the directory structure 100. In other words, an unmatched folder 124 is attached beside each of the top level framework folders 122B1, 122B2, . . . 122Bn.

The content folders of the directory are populated by mapping paragraphs to the directory structure.

By definition paragraphs which were mapped to the unmatched folder 124 were not mapped to any other folder 112, 122, 130 within the expanded skeletal structure 110. Thus, it is necessary to determine whether these paragraphs contain pertinent concepts which should be added to the skeletal structure 120.

The process for identifying concepts for inclusion in the framework structure is identical to the process of steps 300-22 through 300-32.

A frequency table 180 (FIG. 9) is compiled from the paragraphs mapped to the unmatched folder 124 (step 300-22). The frequency table 180 includes one, two, three and four word combinations from each sentence within the paragraphs mapped to the unmatched folder 124.

Noise combinations in the frequency table 180 are removed from further consideration (step 300-24). According to a presently preferred embodiment, noise combinations are determined using first and second threshold values, however, acceptable results may also be obtained using only the second threshold value. 300-26

Noise combinations in the frequency table 180 are removed from further consideration (step 300-24). According to a presently preferred embodiment, noise combinations are determined using first and second threshold values, however, acceptable results may also be obtained using only the second threshold value.

The first threshold is empirically determined as a positional frequency. According to a presently preferred embodiment, the first threshold is defined to exclude the top two most frequently occurring combinations.

A second threshold is calculated by taking the frequency value of the highest combination that is smaller than the first threshold and dividing it by the average frequency of the top 100 combinations.

Extract word combinations whose frequency is lower than a first threshold but higher than a second threshold.

A thesaurus 160 is table of records 162, where each record 162 contains synonymous terminology within the context of a specific field of knowledge. FIG. 10 is a sample thesaurus 160 of legal terminology.

The thesaurus 160 is used to detect synonymous terminology within the frequency table 180. The synonymous terminology and its associated frequency values are removed from the frequency table 180, and replaced by a single synonymous word or word combination with a frequency value calculated as the sum of the individual frequencies of the synonymous terminology (step 300-26).

It is now necessary to examine the word combinations in the frequency table 180 to determine whether the combinations are indicative of framework folders (concepts) 122 missing from the framework structure 120, or whether the folder definition 128 of an existing framework folder 122 should be optimized to detect the word combination. More precisely, the user extrapolates concepts from the word combinations in the frequency table 180 based on his/her knowledge of the subject of the directory (step 300-28).

The user knows from experience that selected word combinations are used to describe a selected concept, and then checks whether an existing framework folder 122 corresponds to the extrapolated concept. If so, the concept definition 128 of the corresponding framework folder 122 needs to be optimized to detect the word combination (step 300-30).

If no existing folder 112, 122, 130 corresponds to the extrapolated concept, then a new skeletal folder 112 may need to be defined whose concept definition detects the word combination (step 300-32). Alternatively, the word combination may be irrelevant (noise) to the framework structure 120.

A final yet important aspect of the disclosed invention relates to the framework structure 120 used to expand the skeletal structure 10. Notably, changes to the framework structure 110 will result in corresponding changes throughout the expanded skeletal structure.

For example, if a change is made in the folder definition 128 within the framework structure 120 (FIG. 2B), the change is dynamically reflected in the corresponding framework folders 122 within the expanded skeletal structure 110 (FIG. 11).

Similarly, if a new framework folder 122 is added to the framework structure 120, then the change is dynamically reflected in each of the places where the framework structure 120 was appended.

However, if a change is made to a framework folder 122 within the expanded skeletal structure 110, the change is not dynamically reflected back to the framework structure 120 or to any of the corresponding framework folders 122 within the expanded skeletal structure 110.

Moreover, modification of a folder definition 128 within the framework structure 120 will not over-ride the local changes to the folder definition 128 within the expanded skeletal structure 110.

While the invention has been described with reference to certain preferred embodiments, as will apparent to those of ordinary skill in the art, certain changes and modifications can be made without departing from the scope of the invention as defined by the following claims.

We claim:

1. A systematic method for creating framework folders used to expanding a skeletal structure, comprising the steps of:
collect the folder label for each individual first level skeletal folder and the folder labels of all hierarchically subordinate skeletal folders into separate collections;
remove predefined noise words from each collection of folder labels;
tabulate a separate frequency table for each collection, counting the single word frequency of each word a given collection of folder labels;
remove words from each frequency table whose frequency falls below a predetermined threshold;
combine the individual frequency tables into a combined frequency table;
output the results of the combined frequency table, wherein a directory editor extrapolates concepts from the results of the combined frequency table and creates a new framework folder for each extrapolated concept.

2. A method for optimizing a framework structure, comprising the steps of:
append an unmatched folder to the framework structure;
map a collection of paragraphs to the framework structure;
compile a frequency table of one, two, three and four words combinations from the paragraphs mapped to the unmatched folder;
remove noise combinations from the frequency table; and
output the results of the combined frequency table, wherein a directory editor does one of:
extrapolates concepts from the results of the frequency table and creates a new framework folder for each extrapolated concept; and
optimizes the framework folder definition(s) to detect the concept conveyed in the paragraphs mapped to the unmatched folder.

3. A method for systematically expanding a skeletal structure:
creating a framework structure from the folder labels of the skeletal structure; and
appending a copy of the framework structure to each skeletal end folder.

4. The method according to claim 3 further comprising the steps of:
mapping a collection of paragraphs to the expanded skeletal structure;
tabulating a number of paragraphs mapped to each end-folder of the expanded skeletal structure; and
deleting a selected end-folder if the number of paragraphs mapped to the selected end-folder is below a predetermined threshold.

5. The method according to claim 4 further comprising the steps of:
mapping a collection of paragraphs to the expanded skeletal structure;
tabulating a number of paragraphs mapped to each end-folder of the expanded skeletal structure;
flagging a selected end-folder if the number of paragraphs mapped to the selected end-folder is above a predetermined threshold;
copy the folder label of each flagged end-folder and redact the copied folder label to remove noise words;
for each of the paragraphs mapped to a flagged end-folder, extract sentences which contain the redacted folder label;
tabulate a frequency table one, two, three and four word combinations that re-occur in the extracted sentences;
remove predefined noise combinations from the frequency table
retain a predetermined number of the most highest frequency word combinations; and
create an expansion folder for each retained word combination.

6. A method for optimizing a skeletal directory structure, comprising:
append an unmatched folder to the skeletal structure;
map a collection of paragraphs to the skeletal structure;
compile a frequency table of one, two, three and four words combinations from the paragraphs mapped to the unmatched folder;
remove noise combinations from the frequency table; and
output the results of the combined frequency table, wherein a directory editor extrapolates concepts from the results of the frequency table, if the extrapolated concept does not correspond to the label of an existing folder then create a new framework folder for the extrapolated concept(s), otherwise the directory editor optimizes the framework folder definition(s) to detect paragraphs mapped to the unmatched folder.

7. A method for compiling word combinations indicative of concepts for inclusion in a framework structure from the folder labels of a skeletal strcuture:
collect the folder label for each individual first level skeletal folder and the folder labels of all hierarchically subordinate skeletal folders into separate collections;
remove predefined noise words from each collection of folder labels;
tabulate a separate frequency table for each collection, counting the single word frequency of each word a given collection of folder labels;
remove words from each frequency table whose frequency falls below a predetermined threshold; and
combine the individual frequency tables into a combined frequency table; and
output the results of the combined frequency table, wherein the combinations in the combined frequency table are indicative of concepts which should be included within the framework structure.
